(19) United States
(12) Patent Application Publication
(10) Pub. No.: US 2021/0220903 A1
(43) Pub. Date: Jul. 22, 2021

(54) GREEN MOLDING SAND TREATMENT EQUIPMENT MONITORING SYSTEM AND GREEN MOLDING SAND TREATMENT EQUIPMENT MONITORING METHOD

(71) Applicant: SINTOKOGIO, LTD., Nagoya-shi, Aichi (JP)

(72) Inventors: Toshiyuki ISHIKAWA, Toyokawa-shi (JP); Hideki MORIMOTO, Toyokawa-shi (JP); Koji YAMAGUCHI, Toyokawa-shi (JP); Takahiro YAMAMOTO, Toyokawa-shi (JP)

(73) Assignee: SINTOKOGIO, LTD., Nagoya-shi, Aichi (JP)

(21) Appl. No.: 16/755,487

(22) PCT Filed: Oct. 4, 2018
(86) PCT No.: PCT/JP2018/037169

§ 371 Date: Apr. 10, 2020

(30) Foreign Application Priority Data
Nov. 10, 2017 (JP) 2017-216838

(51) Int. Cl. B22C 5/04; B22C 5/18

(52) U.S. Cl. CPC B22C 5/0472; B22C 5/185; B22C 5/0463; B22C 5/0413

(57) ABSTRACT

A green sand treatment equipment monitoring system that detects that the condition of green sand treatment equipment is deteriorating before the green sand treatment equipment fails, or detects that the quality of green sand treated by the green sand treatment equipment and kneaded sand produced from the green sand is deteriorating before it becomes clear that the green sand and the kneaded sand are defective products. The system including: an information collecting device that collects, in real time, data measured by equipment within green sand treatment equipment; and a diagnostic device that compares, in real time, the collected data with a control value, and displays a diagnosis result if the diagnostic device determines that the collected data has deviated from the control value.

### TECHNICAL FIELD

The present invention relates to a green sand treatment equipment monitoring system and a green sand treatment equipment monitoring method.

### BACKGROUND

Casting equipment can be operated continuously for 24 hours in order to increase production efficiency. On the other hand, given that casting equipment is operated continuously for 24 hours, it is necessary for the casting equipment to operate continuously without failure and for the quality of castings produced by the casting equipment to be maintained. Furthermore, in the case of green sand treatment equipment constituting the casting equipment, it is necessary for the green sand treatment equipment to operate continuously without failure and for the quality of green sand treated by the green sand treatment equipment and kneaded sand produced from the green sand to be maintained. For this reason, a 24-hour monitoring system for green sand treatment equipment is desired.

For example, Patent Document 1 discloses a system for remote support in which, when a molding machine in a foundry has trouble, the location of the trouble is identified from video image information taken of the molding machine, voice information obtained by recording a voice regarding the molding machine, and ladder program information from a control device of the molding machine.

### CITATION LIST

### Patent Literature

Patent Document 1: JP 4871412 B

### SUMMARY OF INVENTION

### Technical Problem

However, a monitoring system that detects that the condition of green sand treatment equipment is deteriorating before the green sand treatment equipment fails, or detects that the quality of green sand treated by the green sand treatment equipment and kneaded sand produced from the green sand is deteriorating before it becomes clear that the green sand and the kneaded sand are defective products, has not existed heretofore.

The present invention was made in view of the above, and a purpose of the invention is providing a green sand treatment equipment monitoring system and a green sand treatment equipment monitoring method for monitoring the condition of continuously operating green sand treatment equipment and the quality of green sand treated by the green sand treatment equipment and kneaded sand produced from the green sand.

### Solution to Problem

In order to solve the problem described above and achieve the purpose, the green sand treatment equipment monitoring system in the present invention comprises: an information collecting device that collects, in real time, data measured by equipment within green sand treatment equipment; and a diagnostic device that compares, in real time, the collected data with a control value, and displays a diagnosis result if the diagnostic device determines that the collected data has deviated from the control value.

In addition, the green sand treatment equipment monitoring system in the present invention comprises: an information collecting device that collects, in real time, data measured by equipment within green sand treatment equipment; a diagnostic device that compares, in real time, the collected data with a control value, and transmits a diagnosis result if the diagnostic device determines that the collected data has deviated from the control value; and a diagnosis result reception device that receives and displays the diagnosis result.

In addition, the green sand treatment equipment monitoring method in the present invention comprises: collecting, in real time, data measured by equipment within green sand treatment equipment; and comparing, in real time, the collected data with a control value, and displaying a diagnosis result upon determining that the collected data has deviated from the control value.

In addition, the green sand treatment equipment monitoring method in the present invention comprises: collecting, in real time, data measured by equipment within green sand treatment equipment; a diagnostic device comparing, in real time, the collected data with a control value, and transmitting a diagnosis result to a diagnosis result reception device if the diagnostic device determines that the collected data has deviated from the control value; and the diagnosis result reception device receiving and displaying the diagnosis result.

### Advantageous Effects of Invention

According to the present invention, an effect is provided in which it is possible to detect that the condition of green sand treatment equipment is deteriorating before the green sand treatment equipment fails, or to detect that the quality of green sand treated by the green sand treatment equipment and kneaded sand produced from the green sand is deteriorating before it becomes clear that the green sand and the kneaded sand are defective products.

### BRIEF DESCRIPTION OF DRAWINGS

FIG. 1 is a block diagram representing a functional configuration of a green sand treatment equipment monitoring system according to a first embodiment.

FIG. 2 illustrates a configuration of green sand treatment equipment.

FIG. 3 is a block diagram representing a functional configuration of a diagnostic device.

FIG. 4 illustrates an overview of the green sand treatment equipment monitoring system.

FIG. 5 is a flow chart illustrating a method for monitoring green sand treatment equipment using the green sand treatment equipment monitoring system according to the first embodiment.

FIG. 6 illustrates an example of a screen for setting control values displayed on a display portion.

FIG. 7 illustrates an example of measurement data received by a diagnostic device.

FIG. 8 illustrates an example of measurement data received by a diagnostic device.

FIG. 9 is a block diagram representing a functional configuration of a green sand treatment equipment monitoring system according to a second embodiment.

FIG. 10 illustrates a configuration of green sand treatment equipment.

FIG. 11 is a block diagram representing a functional configuration of a diagnostic device.

FIG. 12 is a block diagram representing a functional configuration of a diagnosis result reception device.

FIG. 13 is a flow chart illustrating a method for monitoring green sand treatment equipment using the green sand treatment equipment monitoring system according to the second embodiment.

FIG. 14 is a block diagram representing a functional configuration of a green sand treatment equipment monitoring system according to a third embodiment.

FIG. 15 illustrates a configuration of green sand treatment equipment.

FIG. 16 is a block diagram representing a functional configuration of a diagnostic device.

FIG. 17 is a block diagram representing a functional configuration of a diagnosis result reception device.

FIG. 18 illustrates an example of map information displayed on a display portion.

FIG. 19 illustrates another example of map information displayed on a display portion.

FIG. 20 illustrates an overview of a green sand treatment equipment monitoring system.

FIG. 21 is a flow chart illustrating a method for monitoring green sand treatment equipment using the green sand treatment equipment monitoring system according to the third embodiment.

FIG. 22 illustrates an example of a report generated by a control portion of a diagnostic device.

FIG. 23 illustrates an example of a screen displayed on a display portion.

FIG. 24 illustrates another example of a screen displayed on a display portion.

### DESCRIPTION OF EMBODIMENTS

Herebelow, embodiments for carrying out the green sand treatment equipment monitoring system and green sand treatment equipment monitoring method according to the present invention will be described on the basis of drawings, with reference to the attached drawings.

### First Embodiment

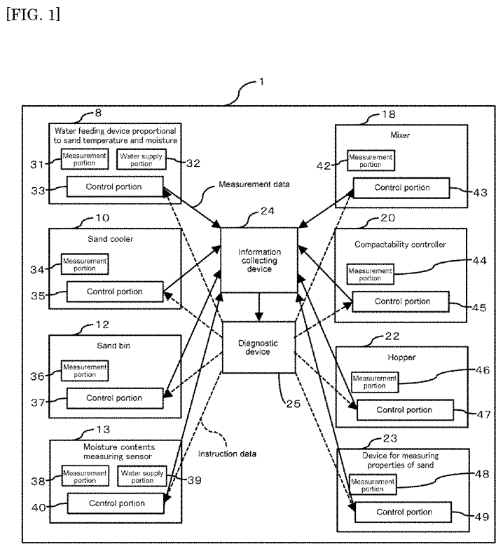

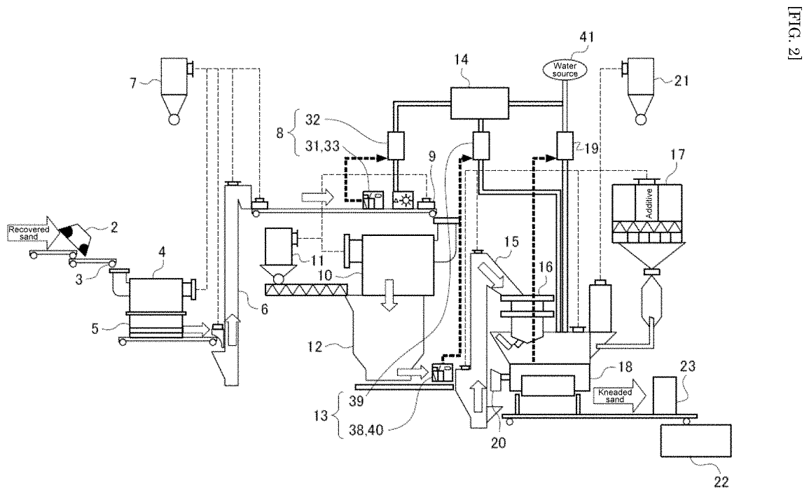

The first embodiment will be explained with reference to the attached drawings. FIG. 1 is a block diagram representing a functional configuration of a green sand treatment equipment monitoring system according to the first embodiment. FIG. 2 illustrates a configuration of green sand treatment equipment.

The green sand treatment equipment monitoring system 1 comprises: green sand treatment equipment, comprising an overband magnetic separator 2, a magnetic pulley 3, a rotary screen 4, a hopper 5, a bucket elevator 6, a dust collector 7, a water feeding device proportional to sand temperature and moisture 8, a sand agitating device 9, a sand cooler 10, a dust collector 11, a sand bin 12, a moisture contents measuring sensor 13, a water pressure regulating device 14, a bucket elevator 15, a weighing instrument 16, an additive feeding device 17, a mixer 18, a mixer water supply tank 19, a compactability controller 20, a dust collector 21, a hopper 22, and a device for measuring properties of sand 23; and further comprises an information collecting device 24 and a diagnostic device 25.

The overband magnetic separator 2 and the magnetic pulley 3 magnetically separate recovered sand (green sand) recovered from green sand casting equipment to separate and remove iron pieces from the recovered sand. The rotary screen 4 continuously breaks up the recovered sand. The hopper 5 stores the recovered sand that has been broken up. The bucket elevator 6 conveys the recovered sand stored in the hopper 5. The dust collector 7 collects dust generated in the rotary screen 4 and dust generated during conveyance by the bucket elevator 6.

The water feeding device proportional to sand temperature and moisture 8, which is one of the units of green sand treatment equipment, measures the temperature and moisture content of the recovered sand conveyed via the bucket elevator 6 and supplies an amount of water (cooling water) proportional to a measured value to the recovered sand. The water feeding device proportional to sand temperature and moisture 8 is referred to as MIAII. The water feeding device proportional to sand temperature and moisture 8 comprises a measurement portion 31, a water supply portion 32, and a control portion 33. The measurement portion 31 measures the temperature and moisture content of the recovered sand. The water supply portion 32 supplies water to the recovered sand.

The control portion 33 controls the operation of the water feeding device proportional to sand temperature and moisture 8. For example, the control portion 33 determines the amount of cooling water that needs to be supplied based on the temperature and moisture content of the recovered sand measured by the measurement portion 31, and instructs the water supply portion 32 to supply the determined amount of water to be supplied. All of the measurement data regarding the temperature and moisture content is aggregated into the control portion 33. The control portion 33 is a computer or a PLC (programmable logic controller).

The sand agitating device 9 mixes water (cooling water) supplied from the water supply portion 32 of the water feeding device proportional to sand temperature and moisture 8 into recovered sand.

The sand cooler 10, which is one of the units of green sand treatment equipment, cools the recovered sand. The sand cooler 10 is referred to as RCT. The sand cooler 10 comprises a measurement portion 34 and a control portion 35. The measurement portion 34 measures the temperature of the recovered sand at an outlet part of the sand cooler 10.

The control portion 35 operates the sand cooler 10 and cools recovered sand by means of natural cooling. The control portion 35 is a computer or a PLC.

The dust collector 11 collects dust generated during agitation by the sand agitating device 9 and dust generated in the sand cooler 10.

The sand bin 12, which is one of the units of green sand treatment equipment, stores the recovered sand from the sand cooler 10. The sand bin 12 is referred to as BIN. The sand bin 12 comprises a measurement portion 36 and a control portion 37. The measurement portion 36 measures the amount of recovered sand (height of the sand) stored in the sand bin 12. The control portion 37 controls the operation of the sand bin 12. All of the measurement data regarding the amount of recovered sand is aggregated into the control portion 37. The control portion 37 is a computer or a PLC.

The moisture contents measuring sensor 13, which is one of the units of green sand treatment equipment, measures the temperature and moisture content of the recovered sand discharged from the sand bin 12. In addition, after the recovered sand is conveyed to the mixer 18, the moisture contents measuring sensor 13 supplies a predetermined amount of water to the mixer 18 at the start of a kneading step for kneading the recovered sand with an additive. The moisture contents measuring sensor 13 is referred to as BMIC. The moisture contents measuring sensor 13 comprises a measurement portion 38, a water supply portion 39, and a control portion 40. The measurement portion 38 measures the temperature and moisture content of the recovered sand. The water supply portion 39 supplies water to the mixer 18 after the recovered sand is conveyed to the mixer 18.

The control portion 40 controls the operation of the moisture contents measuring sensor 13. For example, the control portion 40 determines the amount of water that needs to be supplied based on the temperature and moisture content of the recovered sand measured by the measurement portion 38, and instructs the water supply portion 39 to supply the determined amount of water to be supplied. All of the measurement data regarding the temperature and moisture content is aggregated into the control portion 40. The control portion 40 is a computer or a PLC.

The water pressure regulating device 14 regulates the pressure of water from a water source 41 and sends this water to the water feeding device proportional to sand temperature and moisture 8 and the moisture contents measuring sensor 13. The bucket elevator 15 conveys recovered sand stored in the sand bin 12 to the weighing instrument 16. The weighing instrument 16 stores the recovered sand and feeds a predetermined amount of the recovered sand, which has been weighed using a sand weighing means (not shown) provided therein, into the mixer 18. The additive feeding device 17 releases an additive into the mixer 18 in response to an instruction from the mixer 18 or an instruction from an operator.

The mixer 18, which is one of the units of green sand treatment equipment, adds and kneads water supplied from the moisture contents measuring sensor 13, the recovered sand (green sand) fed from the weighing instrument 16, and an additive fed from the additive feeding device 17 to produce kneaded sand. The mixer 18 is referred to as MS. The mixer 18 comprises a measurement portion 42 and a control portion 43. The measurement portion 42 measures the operating time of the mixer 18. The control portion 43 controls the operation of the mixer 18. All of the measurement data pertaining to the kneading step in the mixer 18 is aggregated into the control portion 43. The control portion 43 is a computer or a PLC.

The mixer water supply tank 19 supplies additional water from the water source 41 during the kneading step.

The compactability controller 20, which is one of the units of green sand treatment equipment, measures the temperature, moisture content, and CB value (compactability value) of kneaded sand in the mixer 18, and supplies additional water to the mixer 18 during the kneading step. The CB value represents a property of kneaded sand. The compactability controller 20 is referred to as MIEII. The compactability controller 20 comprises a measurement portion 44 and a control portion 45. The measurement portion 44 measures the temperature, moisture content, and CB value of kneaded sand. The control portion 45 controls the mixer water supply tank 19 and the operation of the compactability controller 20.

For example, the control portion 45 determines the additional amount of water that needs to be supplied based on the temperature, moisture content, and CB value of kneaded sand measured by the measurement portion 44, and instructs the mixer water supply tank 19 to supply the determined additional amount of water to be supplied. All of the measurement data regarding the temperature, moisture content, and CB value is aggregated into the control portion 45. The control portion 45 is a computer or a PLC. In addition, the CB value can be stabilized with a short kneading time by combining the moisture contents measuring sensor 13 and the compactability controller 20.

The dust collector 21 collects dust generated during conveyance by the bucket elevator 15, dust generated in the additive feeding device 17, and dust generated during the kneading step in the mixer 18.

The hopper 22, which is one of the units of green sand treatment equipment, stores kneaded sand produced by the mixer 18. The hopper 22 is referred to as HOPPER. The hopper 22 comprises a measurement portion 46 and a control portion 47. The measurement portion 46 measures the amount of kneaded sand (height of the sand) stored in the hopper 22. The control portion 47 controls the operation of the hopper 22. All of the measurement data regarding the amount of kneaded sand is aggregated into the control portion 47. The control portion 47 is a computer or a PLC.

The device for measuring properties of sand 23, which is one of the units of green sand treatment equipment, measures the temperature, moisture content, CB value, air permeability, and compressive strength of the kneaded sand stored in the hopper 22. The device for measuring properties of sand 23 is referred to as IDST. The device for measuring properties of sand 23 comprises a measurement portion 48 and a control portion 49. The measurement portion 48 measures the temperature, moisture content, CB value, air permeability, and compressive strength of the kneaded sand. The control portion 49 controls the device for measuring properties of sand 23.

For example, the control portion 49 determines whether the kneaded sand is in a usable condition at a casting step based on the temperature, moisture content, CB value, air permeability, and compressive strength of the kneaded sand measured by the measurement portion 48. All of the measurement data regarding the temperature, moisture content, and CB value is aggregated into the control portion 49. The control portion 49 is a computer or a PLC.

### (Information Collecting Device)

The information collecting device 24 collects, in real time, data measured by the devices of the green sand treatment equipment (the water feeding device proportional to sand temperature and moisture 8, the sand cooler 10, the sand bin 12, the moisture contents measuring sensor 13, the mixer 18, the compactability controller 20, the hopper 22, and the device for measuring properties of sand 23). Specifically, the information collecting device 24 collects, in real time: measurement data aggregated into the control portion 33 of the water feeding device proportional to sand temperature and moisture 8; measurement data aggregated into the control portion 35 of the sand cooler 10; measurement data aggregated into the control portion 37 of the sand bin 12; measurement data aggregated into the control portion 40 of the moisture contents measuring sensor 13; measurement data aggregated into the control portion 43 of the mixer 18; measurement data aggregated into the control portion 45 of the compactability controller 20; measurement data aggregated into the control portion 47 of the hopper 22; and measurement data aggregated into the control portion 49 of the device for measuring properties of sand 23. The information collecting device 24 is a data logger.

In the present embodiment, data from the control portions of the devices of the green sand treatment equipment is collected in one information collecting device 24, but the same number of information collecting devices 24 as there are devices in the green sand treatment equipment may be provided to collect data from the control portions of the devices in separate information collecting devices 24.

### (Diagnostic Device)

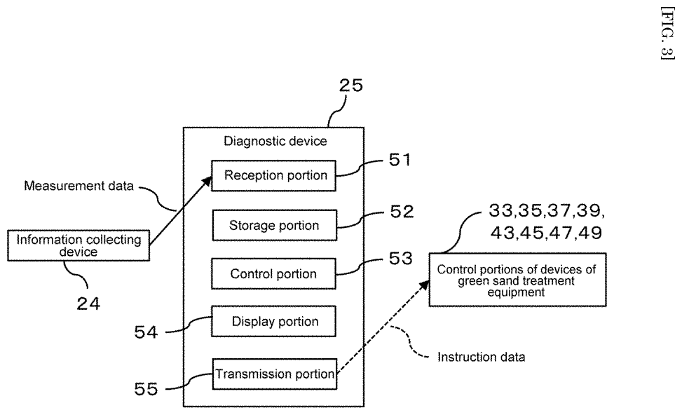

The diagnostic device 25 uses the collected measurement data to diagnose the condition of the devices of the green sand treatment equipment and the quality of green sand treated by the green sand treatment equipment and kneaded sand produced from the green sand. FIG. 3 is a block diagram representing a functional configuration of the diagnostic device 25. The diagnostic device 25 comprises a reception portion 51, a storage portion 52, a control portion 53, a display portion 54, and a transmission portion 55.

The reception portion 51 receives, in real time, measurement data collected by the information collecting device 24. The storage portion 52 stores the received measurement data. Control values corresponding to measurement data in the devices of the green sand treatment equipment and countermeasures for when there is deviation from the control values are also pre-stored in the storage portion 52. Furthermore, the storage portion 52 stores reports generated by the control portion 53.

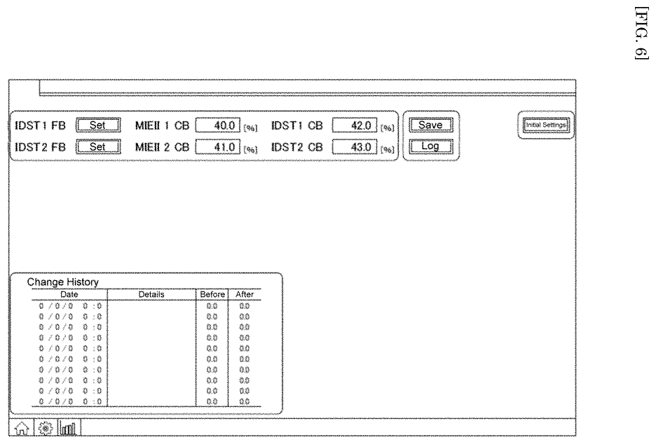

FIG. 6 illustrates an example of a screen for setting control values displayed on the display portion 54. In the present drawing, CB values are set for compactability controllers 20 (MIEII) and device for measuring properties of sands 23 (IDST). These control values are stored in the storage portion 52.

The control portion 53 compares, in real time, collected measurement data with the control values, and upon determining that the collected data has deviated from a control value, causes the display portion 54 to display a diagnosis result (warning) indicating that there is a risk that a fault will occur. Furthermore, the control portion 53 causes the transmission portion 55 to transmit, to the device of the green sand treatment equipment that has deviated from the control value, instruction data for changing a setting condition in the device so that the control value is not exceeded. Furthermore, the control portion 53 periodically generates a report based on the collected data.

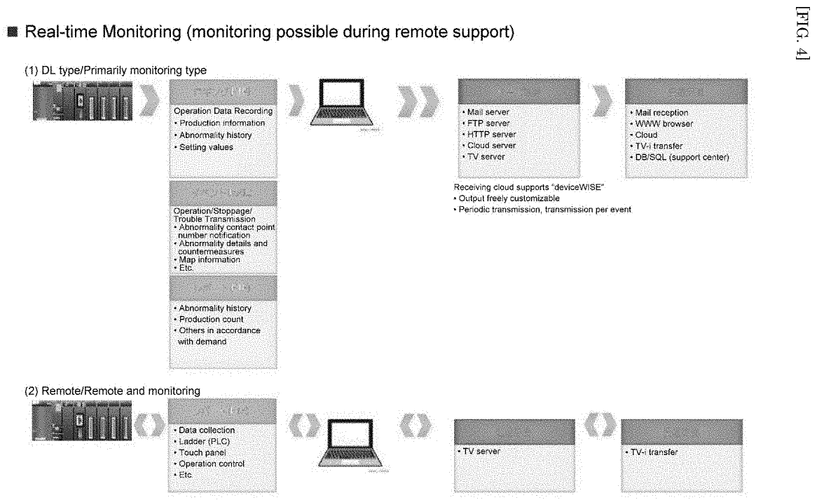

The display portion 54 displays the measurement data received by the reception portion 51 or a report generated by the control portion 53, and a diagnosis result (warning). The transmission portion 55 transmits instruction data to the device of the green sand treatment equipment that has deviated from the control value. The diagnostic device 25 is a computer. FIG. 4 illustrates an overview of the green sand treatment equipment monitoring system 1.

### (Method for Monitoring Green Sand Treatment Equipment)

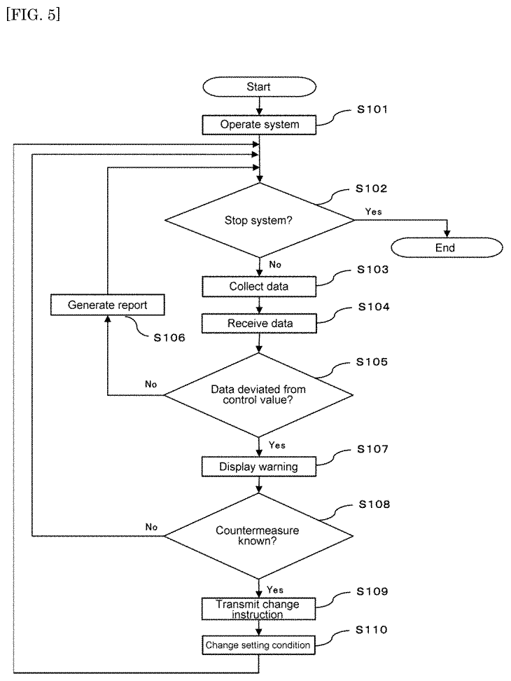

Next, the method for monitoring green sand treatment equipment using the green sand treatment equipment monitoring system 1 according to the first embodiment will be explained. FIG. 5 is a flow chart illustrating the method for monitoring green sand treatment equipment using the green sand treatment equipment monitoring system 1 according to the first embodiment.

First, the green sand treatment equipment monitoring system 1 (devices of the green sand treatment equipment) is operated (step S101). Then, the green sand treatment equipment is continuously monitored until the green sand treatment equipment monitoring system 1 (devices of the green sand treatment equipment) stops (step S102: Yes).

Simultaneously with the operation of the green sand treatment equipment monitoring system 1, the information collecting device 24 collects, in real time, data measured by the water feeding device proportional to sand temperature and moisture 8, the sand cooler 10, the sand bin 12, the moisture contents measuring sensor 13, the mixer 18, the compactability controller 20, the hopper 22, and the device for measuring properties of sand 23 (step S103).

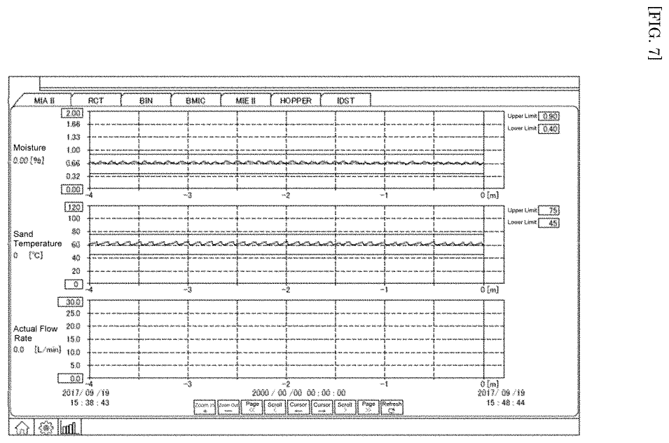

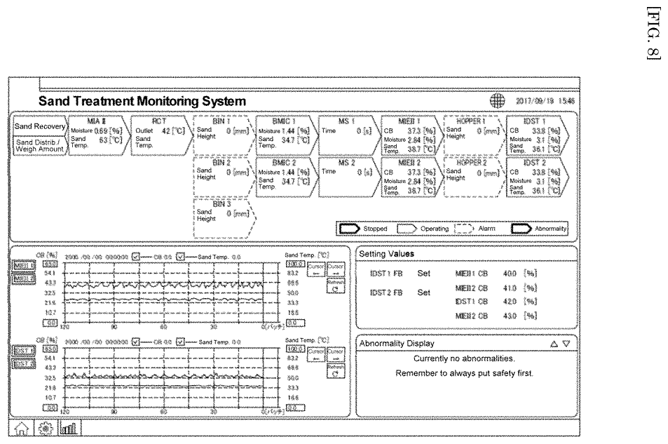

Next, the reception portion 51 of the diagnostic device 25 receives, in real time, the measurement data collected by the information collecting device 24 (step S104). FIGS. 7 and 8 illustrate examples of measurement data received by the diagnostic device 25. FIG. 7 illustrates measurement data collected from the water feeding device proportional to sand temperature and moisture 8 (MIAII) in the form of raw data. On the other hand, FIG. 8 illustrates measurement data collected from the equipment of the green sand treatment equipment, not in the form of raw data, but rather in the form of edited data that is displayed on the display portion 54.

Next, the control portion 53 of the diagnostic device 25 compares, in real time, the received measurement data with control values pre-stored in the storage portion 52 of the diagnostic device 25 (step S105). If the control portion 53 determines that the measurement data has not deviated from a control value (step S105: No), data collection continues.

Then, the control portion 53 periodically generates a report based on the collected data (step S106). The time for collecting information in order to generate a report may be arbitrary. For example, a report may be automatically generated every eight hours and stored in the storage portion 52 of the diagnostic device 25 so that an operator can check the report later on.

On the other hand, if the control portion 53 determines that the measurement data has deviated from the control value (step S105: Yes), the display portion 54 of the diagnostic device 25 displays a diagnosis result (warning) indicating that there is a risk that a fault will occur (step S107). For example, in the measurement data collected from the compactability controller 20, if the CB value has deviated from the lower limit of the control value, a diagnosis result (warning) is displayed indicating that there is a risk that a fault will occur in the compactability controller 20 (mixer 18).

Furthermore, if a specific method for dealing with the fault is known (step S108: Yes), the control portion 53 transmits instruction data from the transmission portion 55 of the diagnostic device 25 to the equipment (any of the water feeding device proportional to sand temperature and moisture 8, the sand cooler 10, the sand bin 12, the moisture contents measuring sensor 13, the mixer 18, the compactability controller 20, the hopper 22, and the device for measuring properties of sand 23) within the green sand treatment equipment in which the measurement data has deviated from the control value, the instruction data instructing the equipment to change a setting condition so that the control value is not exceeded (step S109).

For example, in the measurement data collected from the compactability controller 20, if the CB value has deviated from the lower limit of the control value, instruction data that causes the mixer water supply tank 19 to increase the supply of water by a predetermined value is transmitted to the control portion 45 of the compactability controller 20 such that the moisture in the mixer 18 increases and returns to the range of the control values. Note that, depending on the type of control value, instruction data that stops the equipment is transmitted in some cases.

One of the control portions 33, 35, 37, 40, 43, 45, 47, 49 of the equipment that has received the instruction data from the diagnostic device 25 changes a setting condition in the equipment on the basis of the instruction data (step S110). For example, the control portion 45 of the compactability controller 20 increases the supply of water by a predetermined value on the basis of the instruction data. As a result, the CB value again comes within range of the control values, and it is possible to obviate the occurrence of a fault due to a decrease in the CB value.

If the control portion 53 does not know a specific method for dealing with the fault (step S108: No), the fault is dealt with by an operator who has checked the diagnosis result (warning) displayed on the display portion 54, and even after a setting condition has been changed, data collection continues (step S103), and the monitoring of the green sand treatment equipment by the diagnostic device 25 continues.

As mentioned previously, this series of operations is performed until the green sand treatment equipment monitoring system 1 (equipment of the green sand treatment equipment) stops (step S102: Yes). Once the green sand treatment equipment monitoring system 1 (devices of the green sand treatment equipment) stops, the monitoring of the green sand treatment equipment ends.

In the present embodiment, a diagnosis result (warning) is displayed on the display portion 54 when there is a risk that a fault will occur, but the diagnostic device may be configured so as to have a speaker and issue a diagnosis result (warning) as audio, and a configuration is also possible in which a diagnosis result (warning) is issued using both screen display and audio.

In this manner, according to the green sand treatment equipment monitoring system according to the first embodiment, the information collecting device collects, in real time, data measured by the devices of the green sand treatment equipment, and the diagnostic device compares, in real time, the collected measurement data with a control value, and displays a diagnosis result (warning) indicating that there is a risk that a fault will occur if the diagnostic device determines that the collected data has deviated from the control value. This makes it possible to detect that the condition of green sand treatment equipment is deteriorating before the green sand treatment equipment fails, or to detect that the quality of green sand treated by the green sand treatment equipment and kneaded sand produced from the green sand is deteriorating before it becomes clear that the green sand and the kneaded sand are defective products.

In addition, according to the green sand treatment equipment monitoring system according to the first embodiment, if the diagnostic device determines that the collected data has deviated from a control value, the diagnostic device transmits, to the equipment that has deviated from the control value, instruction data for changing a setting condition in the equipment. This makes it possible to automatically stabilize the condition of green sand treatment equipment or the quality of green sand and kneaded sand.

### Second Embodiment

Next, a second embodiment of the green sand treatment equipment monitoring system according to the present invention will be explained. Note that in the second embodiment explained below, the same reference numerals are used in the drawings to designate features common to those in the first embodiment, and descriptions thereof will be omitted. In the second embodiment, diagnosis results and reports generated by a diagnostic device are transmitted to a diagnosis result reception device at a position remote from the green sand treatment equipment monitoring system, and the diagnosis result reception device gives change instructions to the diagnostic device based on diagnosis results.

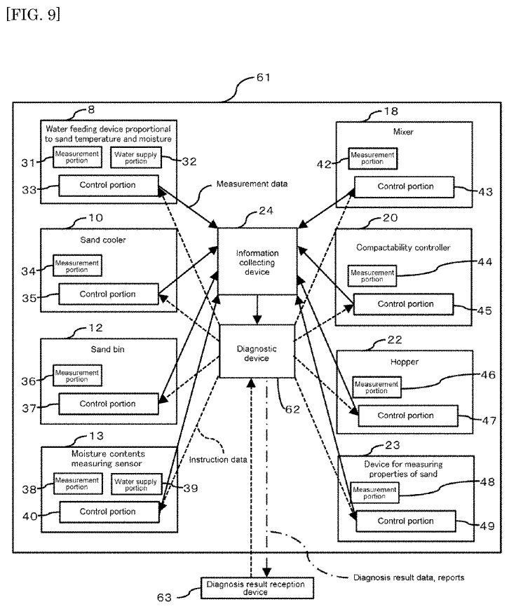

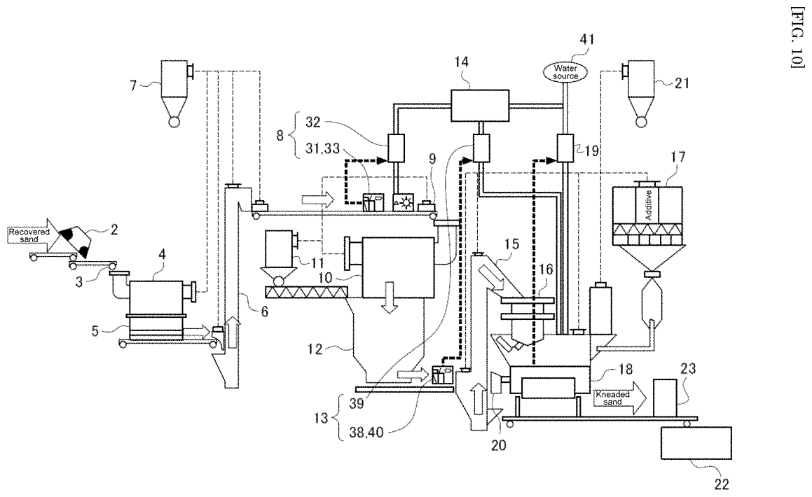

The second embodiment will be explained with reference to the attached drawings. FIG. 9 is a block diagram representing a functional configuration of a green sand treatment equipment monitoring system according to the second embodiment. FIG. 10 illustrates a configuration of green sand treatment equipment. The green sand treatment equipment monitoring system 61 comprises: green sand treatment equipment, comprising an overband magnetic separator 2, a magnetic pulley 3, a rotary screen 4, a hopper 5, a bucket elevator 6, a dust collector 7, a water feeding device proportional to sand temperature and moisture 8, a sand agitating device 9, a sand cooler 10, a dust collector 11, a sand bin 12, a moisture contents measuring sensor 13, a water pressure regulating device 14, a bucket elevator 15, a weighing instrument 16, an additive feeding device 17, a mixer 18, a mixer water supply tank 19, a compactability controller 20, a dust collector 21, a hopper 22, and a device for measuring properties of sand 23; an information collecting device 24; a diagnostic device 62; and a diagnosis result reception device 63.

The overband magnetic separator 2 and the magnetic pulley 3 magnetically separate recovered sand (green sand) recovered from green sand casting equipment to separate and remove iron pieces from the recovered sand. The rotary screen 4 continuously breaks up the recovered sand. The hopper 5 stores the recovered sand that has been broken up. The bucket elevator 6 conveys the recovered sand stored in the hopper 5. The dust collector 7 collects dust generated in the rotary screen 4 and dust generated during conveyance by the bucket elevator 6.

The water feeding device proportional to sand temperature and moisture 8 measures the temperature and moisture content of the recovered sand conveyed via the bucket elevator 6 and supplies an amount of water (cooling water) proportional to a measured value to the recovered sand. The water feeding device proportional to sand temperature and moisture 8 comprises a measurement portion 31, a water supply portion 32, and a control portion 33. The measurement portion 31 measures the temperature and moisture content of the recovered sand. The water supply portion 32 supplies water to the recovered sand. The control portion 33 controls the operation of the water feeding device proportional to sand temperature and moisture 8. All of the measurement data regarding the temperature and moisture content is aggregated into the control portion 33. The control portion 33 is a computer or a PLC.

The sand agitating device 9 mixes water (cooling water) supplied from the water supply portion 32 of the water feeding device proportional to sand temperature and moisture 8 into recovered sand.

The sand cooler 10 cools the recovered sand. The sand cooler 10 is referred to as RCT. The sand cooler 10 comprises a measurement portion 34 and a control portion 35. The measurement portion 34 measures the temperature of the recovered sand at an outlet part of the sand cooler 10. The control portion 35 controls the operation of the sand cooler 10. All of the measurement data regarding the amount of recovered sand is aggregated into the control portion 35. The control portion 35 is a computer or a PLC.

The dust collector 11 collects dust generated during agitation by the sand agitating device 9 and dust generated in the sand cooler 10.

The sand bin 12 stores the recovered sand from the sand cooler 10. The sand bin 12 comprises a measurement portion 36 and a control portion 37. The measurement portion 36 measures the amount of recovered sand (height of the sand) stored in the sand bin 12. The control portion 37 controls the operation of the sand bin 12. All of the measurement data regarding the amount of recovered sand is aggregated into the control portion 37. The control portion 37 is a computer or a PLC.

The moisture contents measuring sensor 13 measures the temperature and moisture content of the recovered sand discharged from the sand bin 12 and, after the recovered sand is conveyed to the mixer 18, supplies a predetermined amount of water to the mixer 18 at the start of the kneading step for kneading the recovered sand with an additive. The moisture contents measuring sensor 13 comprises a measurement portion 38, a water supply portion 39, and a control portion 40. The measurement portion 38 measures the temperature and moisture content of the recovered sand. The water supply portion 39 supplies water to the mixer 18 after the recovered sand is conveyed to the mixer 18. The control portion 40 controls the operation of the moisture contents measuring sensor 13. All of the measurement data regarding the temperature and moisture content is aggregated into the control portion 40. The control portion 40 is a computer or a PLC.

The water pressure regulating device 14 regulates the pressure of water from a water source 41 and sends this water to the water feeding device proportional to sand temperature and moisture 8 and the moisture contents measuring sensor 13. The bucket elevator 15 conveys recovered sand stored in the sand bin 12 to the weighing instrument 16. The weighing instrument 16 stores the recovered sand and feeds a predetermined amount of the recovered sand, which has been weighed using a sand weighing means (not shown) provided therein, into the mixer 18. The additive feeding device 17 releases an additive into the mixer 18 in response to an instruction from the mixer 18 or an instruction from an operator.

The mixer 18 adds and kneads water supplied from the moisture contents measuring sensor 13, the recovered sand (green sand) fed from the weighing instrument 16, and an additive fed from the additive feeding device 17 to produce kneaded sand. The mixer 18 comprises a measurement portion 42 and a control portion 43. The measurement portion 42 measures the operating time of the mixer 18. The control portion 43 controls the operation of the mixer 18. All of the measurement data pertaining to the kneading step in the mixer 18 is aggregated into the control portion 43. The control portion 43 is a computer or a PLC.

The mixer water supply tank 19 supplies additional water from the water source 41 during the kneading step.

The compactability controller 20 measures the temperature, moisture content, and CB value (compactability value) of kneaded sand in the mixer 18, and supplies additional water to the mixer 18 during the kneading step. The compactability controller 20 comprises a measurement portion 44 and a control portion 45. The measurement portion 44 measures the temperature, moisture content, and CB value of kneaded sand. The control portion 45 controls the mixer water supply tank 19 and the operation of the compactability controller 20. All of the measurement data regarding the temperature, moisture content, and CB value is aggregated into the control portion 45. The control portion 45 is a computer or a PLC.

The dust collector 21 collects dust generated during conveyance by the bucket elevator 15, dust generated in the additive feeding device 17, and dust generated during the kneading step in the mixer 18.

The hopper 22 stores kneaded sand produced by the mixer 18. The hopper 22 comprises a measurement portion 46 and a control portion 47. The measurement portion 46 measures the amount of kneaded sand (height of the sand) stored in the hopper 22. The control portion 47 controls the operation of the hopper 22. All of the measurement data regarding the amount of kneaded sand is aggregated into the control portion 47. The control portion 47 is a computer or a PLC.

The device for measuring properties of sand 23 measures the temperature, moisture content, CB value, air permeability, and compressive strength of the kneaded sand stored in the hopper 22. The device for measuring properties of sand 23 comprises a measurement portion 48 and a control portion 49. The measurement portion 48 measures the temperature, moisture content, CB value, air permeability, and compressive strength of the kneaded sand. The control portion 49 controls the device for measuring properties of sand 23. All of the measurement data regarding the temperature, moisture content, CB value, air permeability, and compressive strength is aggregated into the control portion 49. The control portion 49 is a computer or a PLC.

The information collecting device 24 collects, in real time, data measured by the devices of the green sand treatment equipment (the water feeding device proportional to sand temperature and moisture 8, the sand cooler 10, the sand bin 12, the moisture contents measuring sensor 13, the mixer 18, the compactability controller 20, the hopper 22, and the device for measuring properties of sand 23). The information collecting device 24 is a data logger.

### (Diagnostic Device)

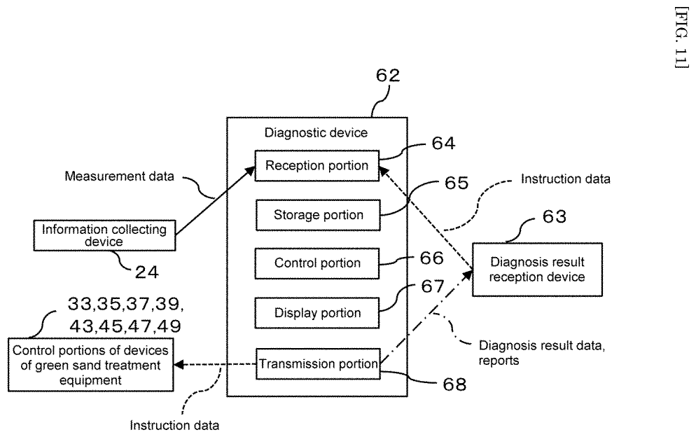

The diagnostic device 62 uses the collected measurement data to diagnose the condition of the devices of the green sand treatment equipment and the quality of green sand treated by the green sand treatment equipment and kneaded sand produced from the green sand. FIG. 11 is a block diagram representing a functional configuration of the diagnostic device 62. The diagnostic device 62 comprises a reception portion 64, a storage portion 65, a control portion 66, a display portion 67, and a transmission portion 68.

The reception portion 64 receives, in real time, measurement data collected by the information collecting device 24, or receives instruction data from the diagnosis result reception device 63. The storage portion 65 stores the received measurement data. Control values corresponding to the measurement data in the devices of the green sand treatment equipment are also pre-stored in the storage portion 65. Furthermore, the storage portion 65 stores reports generated by the control portion 66.

The control portion 66 compares, in real time, the collected measurement data with the control values, and if the control portion 66 determines that collected data has deviated from a control value, the control portion 66 generates diagnosis result data and causes the display portion 67 to display the generated diagnosis result data. Then, the control portion 66 causes the transmission portion 68 to transmit the diagnosis result data. When the control portion 66 receives instruction data from the diagnosis result reception device 63, the control portion 66 causes the transmission portion 68 to transmit the instruction data to the device of the green sand treatment equipment that has deviated from the control value. Furthermore, the control portion 66 periodically generates a report based on the collected data, and causes the transmission portion 68 to transmit the report.

The display portion 67 displays the measurement data received by the reception portion 64 or a report generated by the control portion 66, and a diagnosis result (warning) indicating that there is a risk that a fault will occur. Note that in the present embodiment, the display portion 67 may be omitted in the diagnostic device 62. In this case, the control portion 66 causes the transmission portion 68 to transmit the generated diagnosis result data directly.

The transmission portion 68 transmits diagnosis result data or reports to the diagnosis result reception device 63, and transmits instruction data to the device of the green sand treatment equipment that has deviated from the control value. The diagnostic device 62 is a computer.

Note that in the present embodiment, emails are used when the diagnostic device 62 transmits diagnosis result data or reports to the diagnosis result reception device 63 and when the diagnostic device 62 receives instruction data from the diagnosis result reception device 63, but other methods may be used.

### (Diagnosis Result Reception Device)

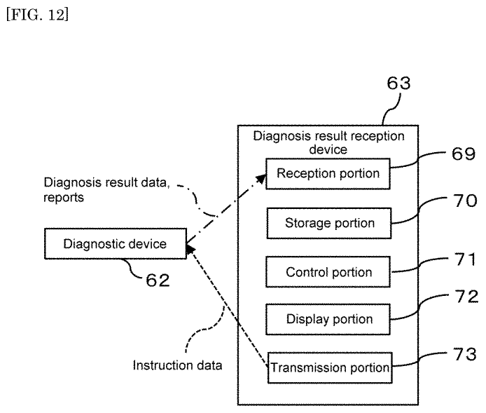

The diagnosis result reception device 63 receives diagnosis result data or reports from the diagnostic device 62. In addition, the diagnosis result reception device 63 gives change instructions to the diagnostic device 62 based on diagnosis result data. The diagnosis result reception device 63 is at a position remote from the green sand treatment equipment, the information collecting device 24, and the diagnostic device 62. FIG. 12 is a block diagram representing a functional configuration of the diagnosis result reception device 63. The diagnosis result reception device 63 comprises a reception portion 69, a storage portion 70, a control portion 71, a display portion 72, and a transmission portion 73.

The reception portion 69 receives diagnosis result data or reports from the diagnostic device 62. The storage portion 70 stores the received diagnosis result data or reports. Countermeasures for when measurement data from devices of the green sand treatment equipment has deviated from control values are also pre-stored in the storage portion 70.

The control portion 71 causes diagnosis results (warnings) indicating that there is a risk that a fault will occur, or reports, to be displayed on the display portion 72 based on diagnosis result data. Furthermore, on the basis of the diagnosis result data, the control portion 71 causes the transmission portion 73 to transmit, to the device of the green sand treatment equipment that has deviated from a control value, instruction data for changing a setting condition in the device so that the control value is not exceeded.

The display portion 72 displays diagnosis results (warnings) or reports. The transmission portion 73 transmits instruction data to the diagnostic device 62. The diagnosis result reception device 63 is a computer.

Note that in the present embodiment, emails are used when the diagnosis result reception device 63 receives diagnosis result data or reports from the diagnostic device 62 and when the diagnosis result reception device 63 transmits instruction data to the diagnostic device 62, but other methods may be used.

### (Method for Monitoring Green Sand Treatment Equipment)

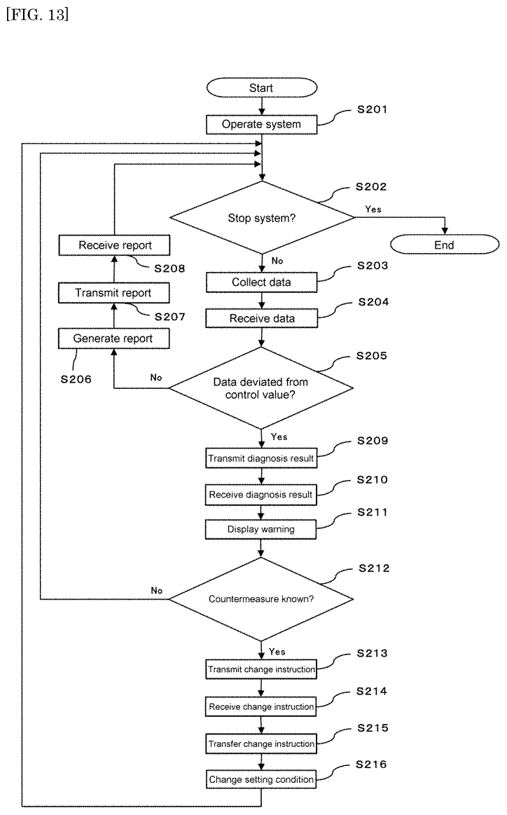

Next, the method for monitoring green sand treatment equipment using the green sand treatment equipment monitoring system 61 according to the second embodiment will be explained. FIG. 13 is a flow chart illustrating the method for monitoring green sand treatment equipment using the green sand treatment equipment monitoring system 61 according to the second embodiment.

First, the green sand treatment equipment monitoring system 61 (devices of the green sand treatment equipment) is operated (step S201). Then, the green sand treatment equipment is continuously monitored until the green sand treatment equipment monitoring system 61 (devices of the green sand treatment equipment) stops (step S202: Yes).

Simultaneously with the operation of the green sand treatment equipment monitoring system 61, the information collecting device 24 collects, in real time, data measured by the water feeding device proportional to sand temperature and moisture 8, the sand cooler 10, the sand bin 12, the moisture contents measuring sensor 13, the mixer 18, the compactability controller 20, the hopper 22, and the device for measuring properties of sand 23 (step S203).

Next, the reception portion 64 of the diagnostic device 62 receives, in real time, the measurement data collected by the information collecting device 24 (step S204).

Next, the control portion 66 of the diagnostic device 62 compares, in real time, the received measurement data with control values pre-stored in the storage portion 65 of the diagnostic device 62 (step S205). If the control portion 66 determines that the measurement data has not deviated from a control value (step S205: No), data collection continues.

Then, the control portion 66 periodically generates a report based on the collected data (step S206). The generated report is transmitted from the transmission portion 68 of the diagnostic device 62 (step S207). The reception portion 69 of the diagnosis result reception device 63 receives the report (step S208) and the report is displayed on the display portion 72 of the diagnosis result reception device 63, which can be checked by an operator.

On the other hand, if the control portion 66 determines that the measurement data has deviated from the control value (step S205: Yes), the control portion 66 generates diagnosis result data and transmits the diagnosis result data from the transmission portion 68 (step S209). For example, in the measurement data collected from the compactability controller 20, if the CB value has deviated from the lower limit of the control value, diagnosis result data indicating this is transmitted.

When the reception portion 69 of the diagnosis result reception device 63 receives the diagnosis result data (step S210), the display portion 72 of the diagnosis result reception device 63 displays a diagnosis result (warning) indicating that there is a risk that a fault will occur (step S211). For example, if the CB value has deviated from the lower limit of the control value, a diagnosis result (warning) is displayed indicating that there is a risk that a fault will occur in the compactability controller 20 (mixer 18).

Furthermore, if a specific method for dealing with the fault is known (step S212: Yes), the control portion 71 of the diagnosis result reception device 63 transmits, from the transmission portion 73 of the diagnosis result reception device 63 to the diagnostic device 62, instruction data for the equipment (any of the water feeding device proportional to sand temperature and moisture 8, the sand cooler 10, the sand bin 12, the moisture contents measuring sensor 13, the mixer 18, the compactability controller 20, the hopper 22, and the device for measuring properties of sand 23) within the green sand treatment equipment in which the measurement data has deviated from the control value, the instruction data instructing the equipment to change a setting condition so that the control value is not exceeded (step S213).

For example, in the measurement data collected from the compactability controller 20, if the CB value has deviated from the lower limit of the control value, instruction data instructing the mixer water supply tank 19 to increase the supply of water by a predetermined value is transmitted to the control portion 45 of the compactability controller 20 such that the moisture in the mixer 18 increases and returns to the range of the control values. Note that, depending on the type of control value, instruction data that stops the equipment is transmitted in some cases.

When the reception portion 64 of the diagnostic device 62 receives the instruction data from the diagnosis result reception device 63 (step S214), the control portion 66 of the diagnostic device 62 transfers the instruction data from the diagnosis result reception device 63 to the equipment within the green sand treatment equipment in which the measurement data has deviated from the control value (step S215). For example, the control portion 66 transfers instruction data to the control portion 45 of the compactability controller 20.

One of the control portions 33, 35, 37, 40, 43, 45, 47, 49 of the equipment that has received the instruction data from the diagnostic device 62 changes a setting condition in the equipment on the basis of the instruction data content (step S216). For example, the control portion 45 of the compactability controller 20 increases the supply of water by a predetermined value on the basis of the instruction data. As a result, the CB value again comes within range of the control values, and it is possible to obviate the occurrence of a fault due to a decrease in the CB value.

If the control portion 71 of the diagnosis result reception device 63 does not know a specific method for dealing with the fault (step S212: No), the fault is dealt with by an operator who has checked the diagnosis result (warning) displayed on the display portion 72, and even after a setting condition has been changed, data collection continues (step S203), and the monitoring of the green sand treatment equipment by the diagnostic device 62 continues.

As mentioned previously, this series of operations is performed until the green sand treatment equipment monitoring system 61 (equipment of the green sand treatment equipment) stops (step S202: Yes). Once the green sand treatment equipment monitoring system 61 (devices of the green sand treatment equipment) stops, the monitoring of the green sand treatment equipment ends.

Note that in the present embodiment, a diagnosis result (warning) is displayed on the display portion 72 of the diagnosis result reception device 63 when there is a risk that a fault will occur, but a diagnosis result (warning) may also be displayed on the display portion 67 of the diagnostic device 62. Also, the diagnostic device 62 and/or the diagnosis result reception device 63 may be configured so as to have a speaker and issue a warning as audio. Furthermore, a configuration is also possible in which a diagnosis result (warning) is issued using both screen display and audio.

In this manner, according to the green sand treatment equipment monitoring system according to the second embodiment: the information collecting device collects, in real time, data measured by the devices of the green sand treatment equipment; the diagnostic device compares, in real time, the collected measurement data with a control value, and transmits a diagnosis result to the diagnosis result reception device if the diagnostic device determines that the collected data has deviated from the control value; and the diagnosis result reception device displays a diagnosis result (warning) indicating that there is a risk that a fault will occur. Consequently, even when distant from the green sand treatment equipment, it is possible to detect that the condition of green sand treatment equipment is deteriorating before the green sand treatment equipment fails, or to detect that the quality of green sand treated by the green sand treatment equipment and kneaded sand produced from the green sand is deteriorating before it becomes clear that the green sand and the kneaded sand are defective products.

In addition, according to the green sand treatment equipment monitoring system according to the second embodiment, the diagnosis result reception device transmits instruction data for changing a setting condition in equipment to the diagnostic device, and the diagnostic device transfers the instruction data to the equipment that has deviated from a control value. This makes it possible to automatically stabilize the condition of green sand treatment equipment or the quality of green sand and kneaded sand even when distant from the green sand treatment equipment.

### Third Embodiment

Next, a third embodiment of the green sand treatment equipment monitoring system according to the present invention will be explained. Note that in the third embodiment explained below, the same reference numerals are used in the drawings to designate features common to those in the second embodiment, and descriptions thereof will be omitted. In the third embodiment, location information data is added to the diagnosis results and the reports generated by the diagnostic device in the second embodiment and transmitted to a diagnosis result reception device at a position remote from the green sand treatment equipment monitoring system.

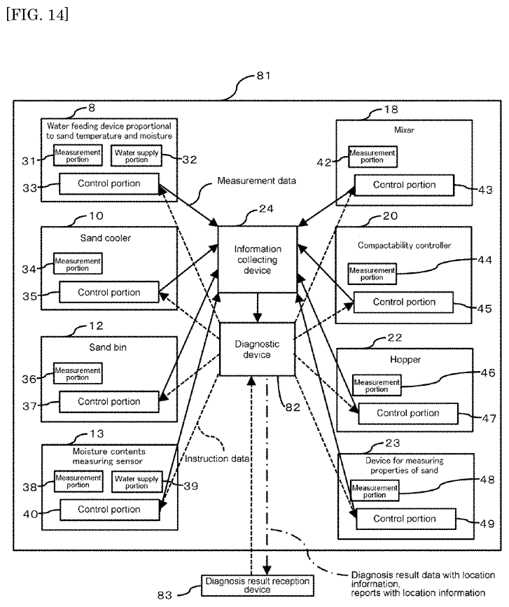

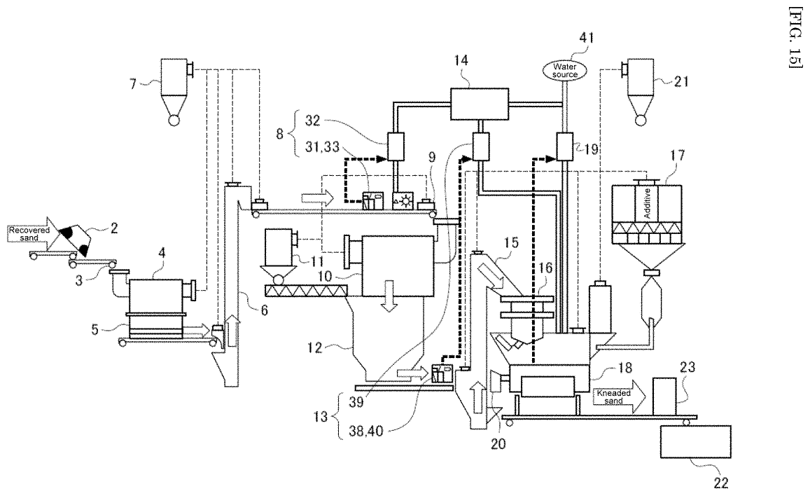

The third embodiment will be explained with reference to the attached drawings. FIG. 14 is a block diagram representing a functional configuration of a green sand treatment equipment monitoring system according to the third embodiment. FIG. 15 illustrates a configuration of green sand treatment equipment. The green sand treatment equipment monitoring system 81 comprises: green sand treatment equipment, comprising an overband magnetic separator 2, a magnetic pulley 3, a rotary screen 4, a hopper 5, a bucket elevator 6, a dust collector 7, a water feeding device proportional to sand temperature and moisture 8, a sand agitating device 9, a sand cooler 10, a dust collector 11, a sand bin 12, a moisture contents measuring sensor 13, a water pressure regulating device 14, a bucket elevator 15, a weighing instrument 16, an additive feeding device 17, a mixer 18, a mixer water supply tank 19, a compactability controller 20, a dust collector 21, a hopper 22, and a device for measuring properties of sand 23; an information collecting device 24; a diagnostic device 82; and a diagnosis result reception device 83.

The overband magnetic separator 2 and the magnetic pulley 3 magnetically separate recovered sand (green sand) recovered from green sand casting equipment to separate and remove iron pieces from the recovered sand. The rotary screen 4 continuously breaks up the recovered sand. The hopper 5 stores the recovered sand that has been broken up. The bucket elevator 6 conveys the recovered sand stored in the hopper 5. The dust collector 7 collects dust generated in the rotary screen 4 and dust generated during conveyance by the bucket elevator 6.

The water feeding device proportional to sand temperature and moisture 8 measures the temperature and moisture content of the recovered sand conveyed via the bucket elevator 6 and supplies an amount of water (cooling water) proportional to a measured value to the recovered sand. The water feeding device proportional to sand temperature and moisture 8 comprises a measurement portion 31, a water supply portion 32, and a control portion 33. The measurement portion 31 measures the temperature and moisture content of the recovered sand. The water supply portion 32 supplies water to the recovered sand. The control portion 33 controls the operation of the water feeding device proportional to sand temperature and moisture 8. All of the measurement data regarding the temperature and moisture content is aggregated into the control portion 33. The control portion 33 is a computer or a PLC.

The sand agitating device 9 mixes water (cooling water) supplied from the water supply portion 32 of the water feeding device proportional to sand temperature and moisture 8 into recovered sand.

The sand cooler 10 cools the recovered sand. The sand cooler 10 is referred to as RCT. The sand cooler 10 comprises a measurement portion 34 and a control portion 35. The measurement portion 34 measures the temperature of the recovered sand at an outlet part of the sand cooler 10. The control portion 35 controls the operation of the sand cooler 10. All measurement data of the amount of recovered sand is aggregated into the control portion 35. The control portion 35 is a computer or a PLC.

The dust collector 11 collects dust generated during agitation by the sand agitating device 9 and dust generated in the sand cooler 10.

The sand bin 12 stores the recovered sand from the sand cooler 10. The sand bin 12 comprises a measurement portion 36 and a control portion 37. The measurement portion 36 measures the amount of recovered sand (height of the sand) stored in the sand bin 12. The control portion 37 controls the operation of the sand bin 12. All of the measurement data regarding the amount of recovered sand is aggregated into the control portion 37. The control portion 37 is a computer or a PLC.

The moisture contents measuring sensor 13 measures the temperature and moisture content of the recovered sand discharged from the sand bin 12 and, after the recovered sand is conveyed to the mixer 18, supplies a predetermined amount of water to the mixer 18 at the start of a kneading step for kneading the recovered sand with an additive. The moisture contents measuring sensor 13 comprises a measurement portion 38, a water supply portion 39, and a control portion 40. The measurement portion 38 measures the temperature and moisture content of the recovered sand. The water supply portion 39 supplies water to the mixer 18 after the recovered sand is conveyed to the mixer 18. The control portion 40 controls the operation of the moisture contents measuring sensor 13. All of the measurement data regarding the temperature and moisture content is aggregated into the control portion 40. The control portion 40 is a computer or a PLC.

The water pressure regulating device 14 regulates the pressure of water from a water source 41 and sends this water to the water feeding device proportional to sand temperature and moisture 8 and the moisture contents measuring sensor 13. The bucket elevator 15 conveys recovered sand stored in the sand bin 12 to the weighing instrument 16. The weighing instrument 16 stores the recovered sand and feeds a predetermined amount of the recovered sand, which has been weighed using a sand weighing means (not shown) provided therein, into the mixer 18. The additive feeding device 17 releases an additive into the mixer 18 in response to an instruction from the mixer 18 or an instruction from an operator.

The mixer 18 adds and kneads water supplied from the moisture contents measuring sensor 13, the recovered sand (green sand) fed from the weighing instrument 16, and an additive fed from the additive feeding device 17 to produce kneaded sand. The mixer 18 comprises a measurement portion 42 and a control portion 43. The measurement portion 42 measures the operating time of the mixer 18. The control portion 43 controls the operation of the mixer 18. All of the measurement data pertaining to the kneading step in the mixer 18 is aggregated into the control portion 43. The control portion 43 is a computer or a PLC.

The mixer water supply tank 19 supplies additional water from the water source 41 during the kneading step.

The compactability controller 20 measures the temperature, moisture content, and CB value (compactability value) of kneaded sand in the mixer 18, and supplies additional water to the mixer 18 during the kneading step. The compactability controller 20 comprises a measurement portion 44 and a control portion 45. The measurement portion 44 measures the temperature, moisture content, and CB value of kneaded sand. The control portion 45 controls the mixer water supply tank 19 and the operation of the compactability controller 20. All of the measurement data regarding the temperature, moisture content, and CB value is aggregated into the control portion 45. The control portion 45 is a computer or a PLC.

The dust collector 21 collects dust generated during conveyance by the bucket elevator 15, dust generated in the additive feeding device 17, and dust generated during the kneading step in the mixer 18.

The hopper 22 stores kneaded sand produced by the mixer 18. The hopper 22 comprises a measurement portion 46 and a control portion 47. The measurement portion 46 measures the amount of kneaded sand (height of the sand) stored in the hopper 22. The control portion 47 controls the operation of the hopper 22. All of the measurement data regarding the amount of kneaded sand is aggregated into the control portion 47. The control portion 47 is a computer or a PLC.

The device for measuring properties of sand 23 measures the temperature, moisture content, CB value, air permeability, and compressive strength of the kneaded sand stored in the hopper 22. The device for measuring properties of sand 23 comprises a measurement portion 48 and a control portion 49. The measurement portion 48 measures the temperature, moisture content, CB value, air permeability, and compressive strength of kneaded sand. The control portion 49 controls the device for measuring properties of sand 23. All of the measurement data regarding the temperature, moisture content, CB value, air permeability, and compressive strength is aggregated into the control portion 49. The control portion 49 is a computer or a PLC.

The information collecting device 24 collects, in real time, data measured by the devices of the green sand treatment equipment (the water feeding device proportional to sand temperature and moisture 8, the sand cooler 10, the sand bin 12, the moisture contents measuring sensor 13, the mixer 18, the compactability controller 20, the hopper 22, and the device for measuring properties of sand 23). The information collecting device 24 is a data logger.

### (Diagnostic Device)

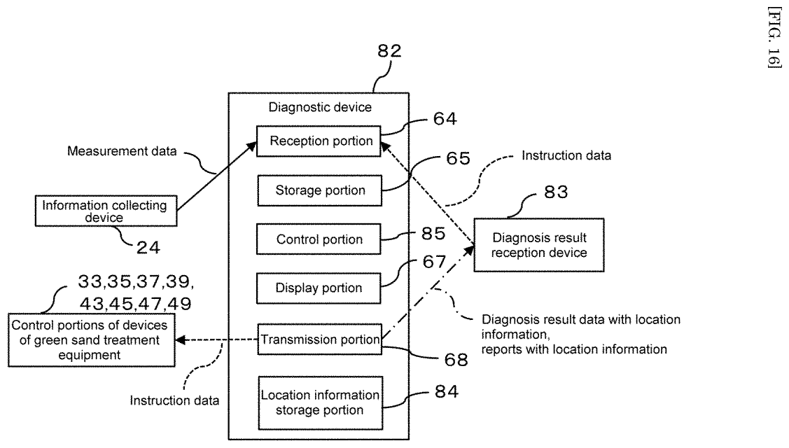

The diagnostic device 82 uses the collected measurement data to diagnose the condition of the devices of the green sand treatment equipment and the quality of green sand treated by the green sand treatment equipment and kneaded sand produced from the green sand. FIG. 16 is a block diagram representing a functional configuration of the diagnostic device 82. The diagnostic device 82 comprises a reception portion 64, a location information storage portion 84, a storage portion 65, a control portion 85, a display portion 67, and a transmission portion 68.

The reception portion 64 receives, in real time, measurement data collected by the information collecting device 24, or receives instruction data from the diagnosis result reception device 83.

Location information data of green sand treatment equipment being monitored by the green sand treatment equipment monitoring system 81 is stored in the location information storage portion 84. Note that the location information data may be not only location information of the green sand treatment equipment as a whole, but also location information regarding each of the devices of the green sand treatment equipment. As the format of the location information data, in some cases, information regarding the latitude and longitude where the devices are located is pre-stored, and in some cases, GPS (Global Positioning System) is integrated into the devices and GPS location information of the devices is stored.

In addition, if GPS has been integrated, the information collecting device 24 may periodically collect GPS location information of the devices. This makes continued monitoring possible even if a device of the green sand treatment equipment has moved for some reason.

Furthermore, GPS may also be integrated into the diagnostic device 82. Even if the diagnostic device 82 is stolen, the data collected until then can be prevented from being stolen by others by setting the data within the diagnostic device 82 to be automatically erased if the diagnostic device 82 moves by at least a predetermined distance (such as 1 km).

The storage portion 65 stores the received measurement data. Control values corresponding to the measurement data in the devices of the green sand treatment equipment are also pre-stored in the storage portion 65. Furthermore, the storage portion 65 stores reports generated by the control portion 85.

The control portion 85 compares, in real time, collected measurement data with the control values, and causes the display portion 67 to display a diagnosis result if the control portion 85 determines that the collected data has deviated from a control value. Then, the control portion 85 adds location information data of the green sand treatment equipment to the generated diagnosis result data, and causes the transmission portion 68 to transmit this data as diagnosis result data with location information. When the control portion 85 receives instruction data from the diagnosis result reception device 83, the control portion 85 causes the transmission portion 68 to transmit the instruction data to the device of the green sand treatment equipment that has deviated from the control value. Furthermore, the control portion 85 periodically generates a report based on the collected data, adds location information data to the generated report, and causes the transmission portion 68 to transmit the report.

The display portion 67 displays the measurement data received by the reception portion 64 or a report generated by the control portion 85, and a diagnosis result (warning) indicating that there is a risk that a fault will occur. Note that in the present embodiment, the display portion 67 may be omitted in the diagnostic device 82. The transmission portion 68 transmits diagnosis result data or reports to the diagnosis result reception device 83, and transmits instruction data to the device of the green sand treatment equipment that has deviated from the control value. The diagnostic device 82 is a computer.

Note that in the present embodiment, emails are used when the diagnostic device 82 transmits diagnosis result data or reports with location information to the diagnosis result reception device 83 and when the diagnostic device 82 receives instruction data from the diagnosis result reception device 83, but other methods may be used.

### (Diagnosis Result Reception Device)

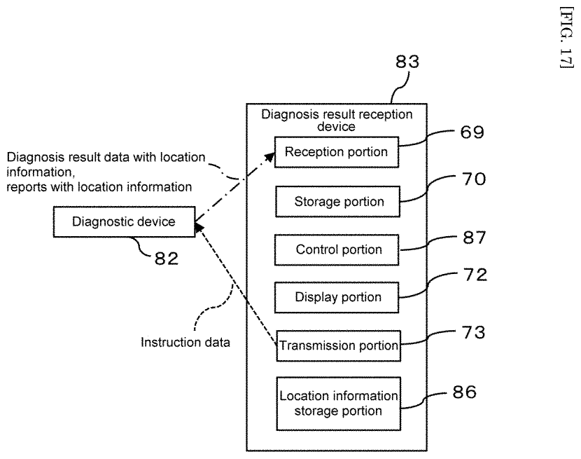

The diagnosis result reception device 83 receives diagnosis result data with location information data or reports with location information data from the diagnostic device 82. In addition, the diagnosis result reception device 83 gives change instructions to the diagnostic device 82 based on the diagnosis result data. The diagnosis result reception device 83 is at a position remote from the green sand treatment equipment, the information collecting device 24, and the diagnostic device 82. FIG. 17 is a block diagram representing a functional configuration of the diagnosis result reception device 83. The diagnosis result reception device 83 comprises a reception portion 69, a location information storage portion 86, a storage portion 70, a control portion 87, a display portion 72, and a transmission portion 73.

The reception portion 69 receives diagnosis result data with location information data or reports with location information data from the diagnostic device 82.

Location information data of green sand treatment equipment being monitored by the green sand treatment equipment monitoring system 81 is stored in the location information storage portion 86.

The storage portion 70 stores received diagnosis result data with location information data or reports with location information data. Countermeasures for when measurement data from devices of the green sand treatment equipment has deviated from control values are also pre-stored in the storage portion 70.

The control portion 87 causes diagnosis results (warnings) indicating that there is a risk that a fault will occur, or reports with location information data, to be displayed on the display portion 72 based on diagnosis result data with location information data. Furthermore, on the basis of diagnosis result data with location information data, the control portion 87 causes the transmission portion 73 to transmit, to the device of the green sand treatment equipment that has deviated from a control value, instruction data for changing a setting condition in the device so that the control value is not exceeded.

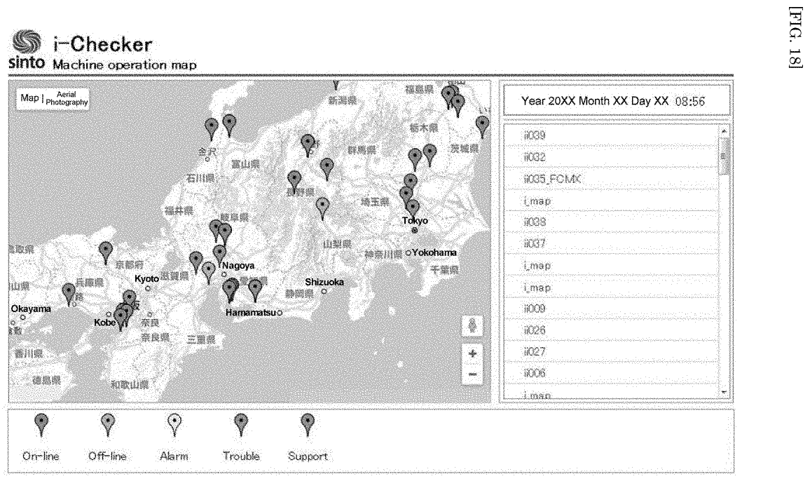

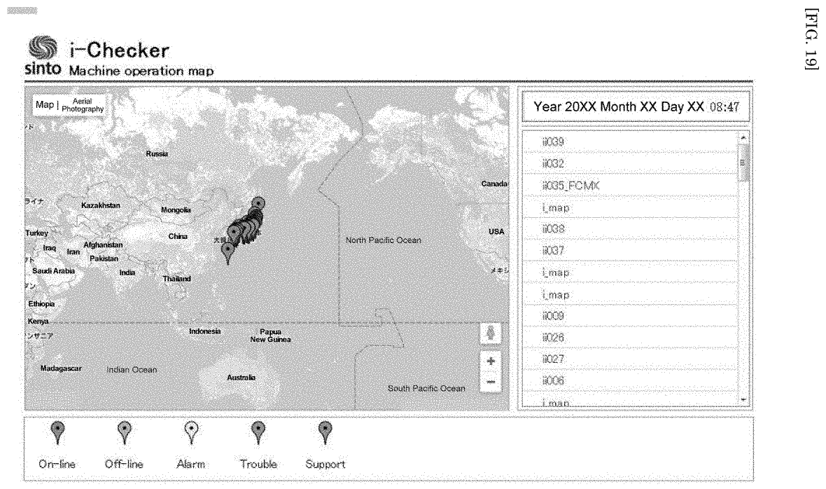

The display portion 72 displays diagnosis results (warnings) or reports. In addition, when displaying a diagnosis result (warning) or a report, the location information data included in diagnosis result data with location information data or in a report with location information data is collated with the location information data stored in the location information storage portion 86, which is displayed together therewith as map information. FIG. 18 illustrates an example of map information displayed on the display portion 72. In addition, FIG. 19 illustrates another example of map information displayed on the display portion 72. Here, FIG. 18 shows a green sand treatment equipment monitoring system 81 built in Japan, while FIG. 19 shows a green sand treatment equipment monitoring system 81 built across the globe.

The transmission portion 73 transmits instruction data to the diagnostic device 82. The diagnosis result reception device 83 is a computer.

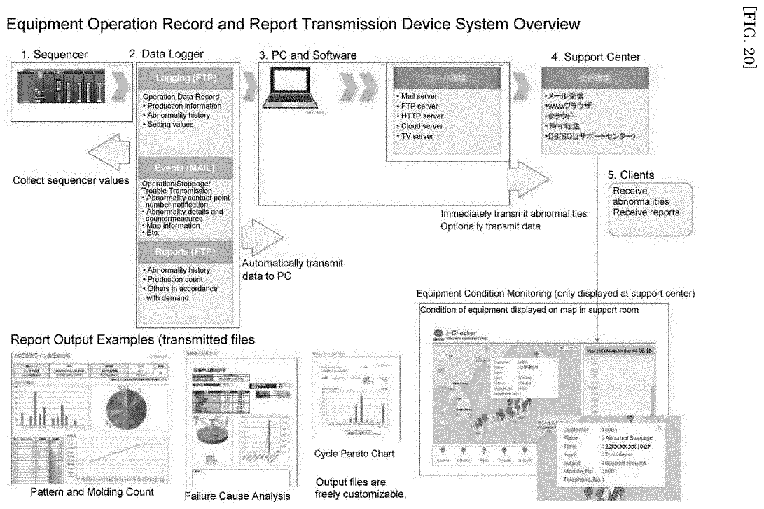

Note that in the present embodiment, emails are used when the diagnosis result reception device 83 receives diagnosis result data or reports with location information from the diagnostic device 82 and when the diagnosis result reception device 83 transmits instruction data to the diagnostic device 82, but other methods may be used. FIG. 20 illustrates an overview of the green sand treatment equipment monitoring system 81.

### (Method for Monitoring Green Sand Treatment Equipment)

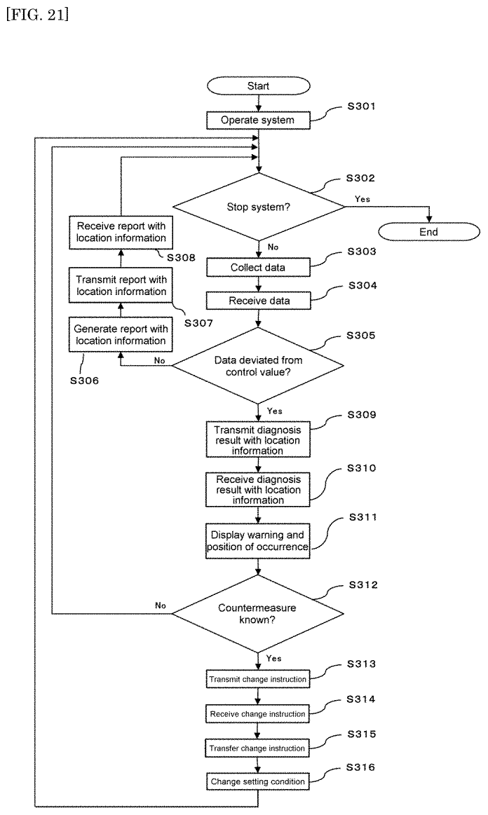

Next, the method for monitoring green sand treatment equipment using the green sand treatment equipment monitoring system 81 according to the third embodiment will be explained. FIG. 21 is a flow chart illustrating the method for monitoring green sand treatment equipment using the green sand treatment equipment monitoring system 81 according to the third embodiment.

First, the green sand treatment equipment monitoring system 81 (devices of the green sand treatment equipment) is operated (step S301). Then, the green sand treatment equipment is continuously monitored until the green sand treatment equipment monitoring system 81 (devices of the green sand treatment equipment) stops (step S302: Yes).

Simultaneously with the operation of the green sand treatment equipment monitoring system 81, the information collecting device 24 collects, in real time, data measured by the water feeding device proportional to sand temperature and moisture 8, the sand cooler 10, the sand bin 12, the moisture contents measuring sensor 13, the mixer 18, the compactability controller 20, the hopper 22, and the device for measuring properties of sand 23 (step S303).

Next, the reception portion 64 of the diagnostic device 82 receives, in real time, the measurement data collected by the information collecting device 24 (step S304).

Next, the control portion 85 of the diagnostic device 82 compares, in real time, the received measurement data with control values pre-stored in the storage portion 65 of the diagnostic device 82 (step S305). If the control portion 85 determines that the measurement data has not deviated from a control value (step S305: No), data collection continues.

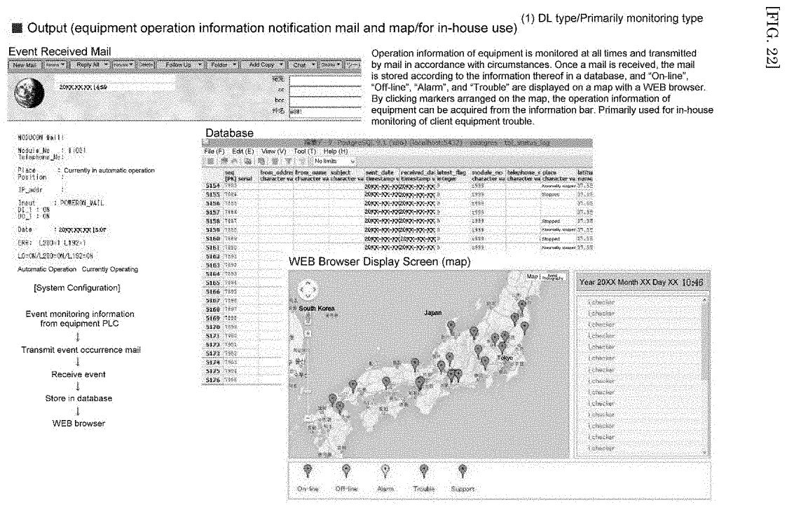

Then, the control portion 85 periodically generates a report with location information from the collected data (step S306). A generated report with location information is transmitted from the transmission portion 68 of the diagnostic device 82 (step S307). The reception portion 69 of the diagnosis result reception device 83 receives the report with location information (step S308), and both the report and a map showing the position of the green sand treatment equipment for which the report was generated are displayed on the display portion 72 of the diagnosis result reception device 83. This allows an operator to easily check the position of the green sand treatment equipment for which the report was generated. FIG. 22 illustrates an example of a report generated by the control portion 85 of the diagnostic device 82.

On the other hand, if the control portion 85 determines that the measurement data has deviated from the control value (step S305: Yes), the control portion 85 generates diagnosis result data with location information and transmits this data from the transmission portion 68 (step S309).

When the reception portion 69 of the diagnosis result reception device 83 receives the diagnosis result data with location information (step S310), the display portion 72 of the diagnosis result reception device 83 displays both a diagnosis result (warning) indicating that there is a risk that a fault will occur and a map showing the position of the green sand treatment equipment for which there is a risk that a fault will occur (step S311). This allows an operator to easily check the position of the green sand treatment equipment for which there is a risk that a fault will occur.

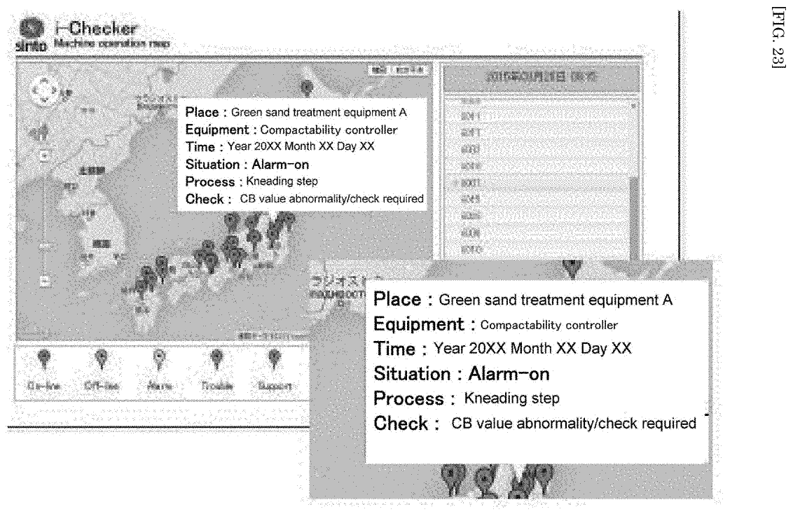

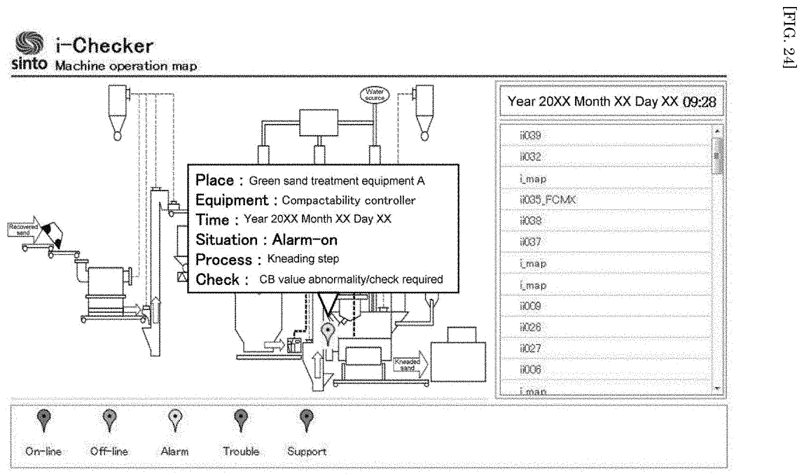

FIG. 23 illustrates an example of a screen displayed on the display portion 72. In the present drawing, it can be understood at a glance that an issue is occurring in the compactability controller 20 of green sand treatment equipment A. The present drawing displays the location of green sand treatment equipment A on a map of Japan, but it is also possible to specifically display the area in the green sand treatment equipment where there is an issue. FIG. 24 illustrates another example of a screen displayed on the display portion 72. In the present drawing, the area where an issue in the compactability controller 20 of green sand treatment equipment A is occurring can be understood at a glance.

Furthermore, in FIGS. 23 and 24, the status of green sand treatment equipment is displayed in different colors, so the condition of the green sand treatment equipment can be recognized at a glance. For example, in FIG. 23, if an issue occurs in green sand treatment equipment, a mark representing the location of the green sand treatment equipment changes from green to red, which allows an operator to quickly become aware that the issue has occurred. Furthermore, in FIG. 24, if an issue occurs in green sand treatment equipment, a mark representing the area in green sand treatment equipment where there is an issue changes from green to red, which allows an operator to quickly become aware of the occurrence of the issue as well as the position of occurrence thereof.

Furthermore, if a specific method for dealing with the fault is known (step S312: Yes), the control portion 87 of the diagnosis result reception device 83 transmits, from the transmission portion 73 of the diagnosis result reception device 83 to the diagnostic device 82, instruction data for the equipment (any of the water feeding device proportional to sand temperature and moisture 8, the sand cooler 10, the sand bin 12, the moisture contents measuring sensor 13, the mixer 18, the compactability controller 20, the hopper 22, and the device for measuring properties of sand 23) within the green sand treatment equipment in which the measurement data has deviated from the control value, the instruction data instructing the equipment to change a setting condition so that the control value is not exceeded (step S313). Note that, depending on the type of control value, instruction data that stops the equipment is transmitted in some cases.

When the reception portion 64 of the diagnostic device 82 receives the instruction data from the diagnosis result reception device 83 (step S314), the control portion 85 of the diagnostic device 82 transfers the instruction data from the diagnosis result reception device 83 to the equipment within the green sand treatment equipment in which the measurement data has deviated from the control value (step S315).

One of the control portions 33, 35, 37, 40, 43, 45, 47, 49 of the equipment that has received the instruction data from the diagnostic device 82 changes a setting condition in the equipment on the basis of the instruction data content (step S316). If the control portion 87 of the diagnosis result reception device 83 does not know a specific method for dealing with the fault (step S312: No), the fault is dealt with by an operator who has checked the diagnosis result (warning) displayed on the display portion 72, and even after a setting condition has been changed, data collection continues (step S303), and the monitoring of the green sand treatment equipment by the diagnostic device 82 continues.

As mentioned previously, this series of operations is performed until the green sand treatment equipment monitoring system 81 (equipment of the green sand treatment equipment) stops (step S302: Yes). Once the green sand treatment equipment monitoring system 81 (devices of the green sand treatment equipment) stops, the monitoring of the green sand treatment equipment ends.

Note that in the present embodiment, both a diagnosis result (warning) and a map showing the position of the green sand treatment equipment are displayed on the display portion 72 of the diagnosis result reception device 83 when there is a risk that a fault will occur, but a diagnosis result (warning) may also be displayed on the display portion 67 of the diagnostic device 82. Also, the diagnostic device 82 and/or the diagnosis result reception device 83 may be configured so as to have a speaker and issue a diagnosis result (warning) as audio. Furthermore, a configuration is also possible in which a diagnosis result (warning) is issued using both screen display and audio.

In this manner, according to the green sand treatment equipment monitoring system according to the third embodiment, the diagnosis result reception device displays both a diagnosis result (warning) indicating that there is a risk that a fault will occur and a map showing the position of green sand treatment equipment for which there is a risk that a fault will occur. This allows an operator to easily check the position of the green sand treatment equipment for which there is a risk that a fault will occur.

In the first to third embodiments, the sand cooler, the sand bin, and the hopper each comprise a control portion, but instead of the sand cooler, the sand bin, and the hopper each comprising a control portion, it is possible to provide a common control portion and to collectively control the sand cooler, the sand bin, and the hopper. Similarly, in the first to third embodiments, the moisture contents measuring sensor and the compactability controller each comprise a control portion, but instead of the moisture contents measuring sensor and the compactability controller each comprising a control portion, it is possible to provide a common control portion and to collectively control the moisture contents measuring sensor and the compactability controller. In such cases, the control portion is a computer or a PLC.

In addition, in the first to third embodiments, the green sand treatment equipment diagnosed by the diagnostic device comprises, but is not limited to, a water feeding device proportional to sand temperature and moisture, a sand cooler, a sand bin, a moisture contents measuring sensor, a mixer, a compactability controller, a hopper, and a device for measuring properties of sand. For example, measurement data pertaining to the amount of additive fed by the additive feeding device can be collected in real time by the information collecting device and diagnosed by the diagnostic device.

In addition, in the first to third embodiments, the information collecting device collects, in real time, the data measured by the green sand treatment equipment, but for example, if an event occurs, such as equipment failure or the occurrence of trouble in equipment, then data is additionally collected from that equipment. This is the same whether, for example, there is a failure due to human error or the occurrence of trouble due to human error.

In addition, in the second and third embodiments, the diagnostic device generates a diagnosis result and a report based on measurement data collected by an information collecting device, and the diagnosis result reception device receives the diagnosis result and the report. However, a configuration is also possible in which the diagnostic device transmits measurement data collected by the information collecting device directly to the diagnosis result reception device and the diagnosis result reception device generates a diagnosis result and a report based on the measurement data.

In addition, in the third embodiment, it is envisaged that GPS is integrated into the diagnostic device, but GPS may also be integrated into the diagnostic device in the first and second embodiments. In this case as well, even if the diagnostic device is stolen, the data collected until then can be prevented from being stolen by others by setting the data within the diagnostic device to be automatically erased if the diagnostic device moves by at least a predetermined distance (such as 1 km).

Various embodiments of the present invention were explained above, but the explanations above are not restrictive of the present invention, and various modifications including the deletion, addition, and substitution of structural components may be contemplated within the technical scope of the present invention.

### REFERENCE SIGNS LIST

1, 61, 81 Green sand treatment equipment monitoring system
2 Overband magnetic separator
3 Magnetic pulley
4 Rotary screen
5, 22 Hopper
6, 15 Bucket elevator
7, 11, 21 Dust collector
8 Water feeding device proportional to sand temperature and moisture
9 Sand agitating device
10 Sand cooler
12 Sand bin
13 Moisture contents measuring sensor
14 Water pressure regulating device
16 Weighing instrument
17 Additive feeding device
18 Mixer
19 Mixer water supply tank
20 Compactability controller
23 Device for measuring properties of sand
24 Information collecting device
25, 62, 82 Diagnostic device
31, 34, 36, 38, 42, 44, 46, 48 Measurement portion
32, 39 Water supply portion
33, 35, 37, 40, 43, 45, 47, 49, 53, 66, 71, 85, 87 Control portion
41 Water source
51, 64, 69 Reception portion
52, 65, 70 Storage portion
54, 67, 72 Display portion
55, 68, 73 Transmission portion
63, 83 Diagnosis result reception device
84, 86 Location information storage portion

1. A green sand treatment equipment monitoring system, comprising:
an information collecting device that collects, in real time, data measured by equipment within green sand treatment equipment; and
a diagnostic device that compares, in real time, the collected data with a control value, and displays a diagnosis result if the diagnostic device determines that the collected data has deviated from the control value.

2. The green sand treatment equipment monitoring system according to claim 1, wherein the diagnostic device, if the collected data has deviated from the control value, further transmits an instruction to the equipment that has deviated from the control value.

3. The green sand treatment equipment monitoring system according to claim 2, wherein the instruction includes content for changing a setting condition in the equipment that has deviated from the control value.

4. The green sand treatment equipment monitoring system according to claim 2, wherein the instruction includes content for stopping the equipment that has deviated from the control value.

5. The green sand treatment equipment monitoring system according to claim 1, wherein the diagnostic device further periodically generates a report based on the collected data.

6. The green sand treatment equipment monitoring system according to claim 1, wherein the diagnostic device, when displaying the diagnosis result, provides location information of the equipment that has deviated from the control value.

7. The green sand treatment equipment monitoring system according to claim 6, wherein the location information further includes location information of the green sand treatment equipment.

8. The green sand treatment equipment monitoring system according to claim 1, wherein the equipment is at least one selected from among a water feeding device proportional to sand temperature and moisture, a sand cooler, a sand bin, a moisture contents measuring sensor, a mixer, a compactability controller, a hopper, and a device for measuring properties of sand.

9. A green sand treatment equipment monitoring system, comprising:
an information collecting device that collects, in real time, data measured by equipment within green sand treatment equipment;
a diagnostic device that compares, in real time, the collected data with a control value, and transmits a diagnosis result if the diagnostic device determines that the collected data has deviated from the control value; and
a diagnosis result reception device that receives and displays the diagnosis result.

10. The green sand treatment equipment monitoring system according to claim 9, wherein the diagnosis result reception device transmits an instruction to the diagnostic device, and the diagnostic device transmits the instruction to the equipment that has deviated from the control value.

11. The green sand treatment equipment monitoring system according to claim 10, wherein the instruction includes content for changing a setting condition in the equipment that has deviated from the control value.

12. The green sand treatment equipment monitoring system according to claim 10, wherein the instruction includes content for stopping the equipment that has deviated from the control value.

13. The green sand treatment equipment monitoring system according to claim 9, wherein transmission and reception between the diagnostic device and the diagnosis result reception device is performed by email.

14. The green sand treatment equipment monitoring system according to claim 9, wherein the diagnosis result reception device changes a color of the diagnosis result with respect to other display content and displays the display content.

15. The green sand treatment equipment monitoring system according to claim 9, wherein the diagnostic device further periodically generates a report based on the collected data and transmits the report to the diagnosis result reception device.

16. The green sand treatment equipment monitoring system according to claim 9, wherein the diagnosis result reception device, when displaying the diagnosis result, provides location information of the equipment that has deviated from the control value.

17. The green sand treatment equipment monitoring system according to claim 9, wherein the equipment is at least one selected from among a water feeding device proportional to sand temperature and moisture, a sand cooler, a sand bin, a moisture contents measuring sensor, a mixer, a compactability controller, a hopper, and a device for measuring properties of sand.

18. A green sand treatment equipment monitoring method, comprising:
collecting, in real time, data measured by equipment within green sand treatment equipment; and
comparing, in real time, the collected data with a control value, and displaying a diagnosis result upon determining that the collected data has deviated from the control value.

19. The green sand treatment equipment monitoring method according to claim 18, wherein an instruction is transmitted to the equipment that has deviated from the control value.

20. The green sand treatment equipment monitoring method according to claim 18, wherein when displaying the diagnosis result, location information of the equipment that has deviated from the control value is provided.

21. A green sand treatment equipment monitoring method, comprising:
collecting, in real time, data measured by equipment within green sand treatment equipment;
a diagnostic device comparing, in real time, the collected data with a control value, and transmitting a diagnosis result to a diagnosis result reception device if the diagnostic device determines that the collected data has deviated from the control value; and
the diagnosis result reception device receiving and displaying the diagnosis result.

22. The green sand treatment equipment monitoring method according to claim 21, wherein the diagnosis result reception device transmits an instruction to the diagnostic device, and the diagnostic device transmits the instruction to the equipment that has deviated from the control value.

23. The green sand treatment equipment monitoring method according to claim 18, wherein the data is also collected if the equipment has failed, or if trouble has occurred in the equipment.

24. The green sand treatment equipment monitoring method according to claim 23, wherein the data is also collected if the equipment has failed due to human error, or if trouble has occurred in the equipment due to human error.

25. The green sand treatment equipment monitoring method according to claim 21, wherein the diagnosis result reception device, when displaying the diagnosis result, provides location information of the equipment that has deviated from the control value.
